(19) United States
(12) Patent Application Publication
(10) Pub. No.: US 2007/0108236 A1
(43) Pub. Date: May 17, 2007

(54) Candy or confection dispenser package

(76) Inventor: Joseph O'Connell, Hershey, PA (US)

Correspondence Address: John F. McNulty;Paul & Paul, 2900 Two Thousand Market Street, Philadelphia, PA, 19103, US

(21) Appl. No.: 11/274,958

(22) Filed: Nov. 15, 2005

(51) Int. Cl. G01F 11/00

(52) U.S. Cl. 222/390

(57) ABSTRACT

A dispensing container is provided for containing and dispensing a viscous candy, gum or like product therefrom, having four molded plastic components, comprising an outer wall member, a bottom member with an upstanding threaded central shaft, a piston engageable with the shaft and upwardly moveable upon rotation of the bottom member, and a one-piece removable cap, with a plurality of openings for discharging of product therefrom.

### BACKGROUND OF THE INVENTION

The present invention is directed to a package for containing and dispensing a candy, confection or the like therefrom, such as taffy, a sugar-based product, a fruit-flavored product, and edible gel-like product, a gum such as chewing gum, bubble gum or the like.

The prior art shows that it is known to dispense an edible candy-like or gum product from a container, wherein the containers are constructed of various molded components, by the use of a rotating mechanism to push product from one end of the container to the other end, and wherein a screw-like member pushes a follower toward a discharge end of the container, for discharge of product from a discharge end of the container.

### SUMMARY OF THE INVENTION

The present invention is directed to providing a dispensing container for dispensing a viscous candy, gum or like product therefrom, having a reduced number of plastic components, in which various beneficial features are provided, such as a shaped discharge at the discharge end of the container, improved sealing features to prevent unwanted discharge of product from a lower end of the container, and wherein improved product-discharge features are provided for manually grasping the container and activating a discharge of product therefrom.

Accordingly, it is a primary object of this invention to provide a novel dispensing container for containing and dispensing a viscous candy, gum or like product therefrom.

It is another object of this invention to accomplish the above object, wherein only four molded plastic components are necessary, comprising an outer wall member, a bottom member with an upstanding thread for moving a piston, a vertically movable piston, and a one-piece removable cap.

It is a further object of this invention to accomplish the above objects, wherein the discharge end of the container and the movable piston are complementally shaped for maximum discharge of product from the container as the piston approaches the upper end of the container.

It is yet another object of this invention to accomplish the above objects, with improved sealing to prevent undesirable discharge of product from locations in the dispensing container from which product is not intended to be discharged.

It is yet another object of this invention to provide a dispensing container with a removable cap that is designed for choke-hazard avoidance.

It is another object of this invention to provide a novel dispensing container for viscous candy, gum or like product therefrom, wherein in a shaped discharge is provided at the discharge end of the container, for providing an enhanced product flow from the container.

Other objects and advantages of the present invention will be readily apparent upon a reading of the following brief descriptions of the drawing figures, the detailed descriptions of the preferred embodiments, and the appended claims.

### BRIEF DESCRIPTIONS OF THE DRAWING FIGURES

FIG. 1 is a vertical sectional view, taken through the dispensing container of this invention, wherein the four components thereof are shown in vertical cross-section.

FIG. 1A is an enlarged detail view of a seal between the vertically movable piston and the stationary cylindrical outer wall of the container.

FIG. 1B is a detail view of a snap-engagement connection between the removable cap of the dispensing container, and the stationary cylindrical outer wall of the container of FIG. 1.

FIG. 2 is a vertical cross-sectional view, taken through the piston of FIG. 1, showing its cylindrical wall-riding seal in its unrestrained position.

FIG. 2A is a top plan view of the piston of FIG. 2.

FIG. 3 is a vertical sectional view, taken through the removable cap of the container of FIG. 1, showing an outer diametral size “D” therefor.

FIG. 3A is a top plan view of the cap of FIG. 3.

FIG. 4 is a vertical sectional view of the bottom member of the four components of the dispensing container of this invention, with the upstanding threaded generally central shaft being clearly illustrated.

FIG. 4A is a top plan view of the member illustrated in FIG. 4, wherein the component of FIG. 4 is illustrated as provided with peripheral undulations for facilitation manual grasping and rotation of the same.

FIG. 5 is a vertical sectional view of the stationary cylindrical outer wall member shown in FIG. 1.

FIG. 5A is a top plan view of the outer wall member illustrated in FIG. 5, with the shaped discharge at its upper end being more clearly illustrated.

### DETAILED DESCRIPTION OF THE PREFERRED EMBODIMENTS

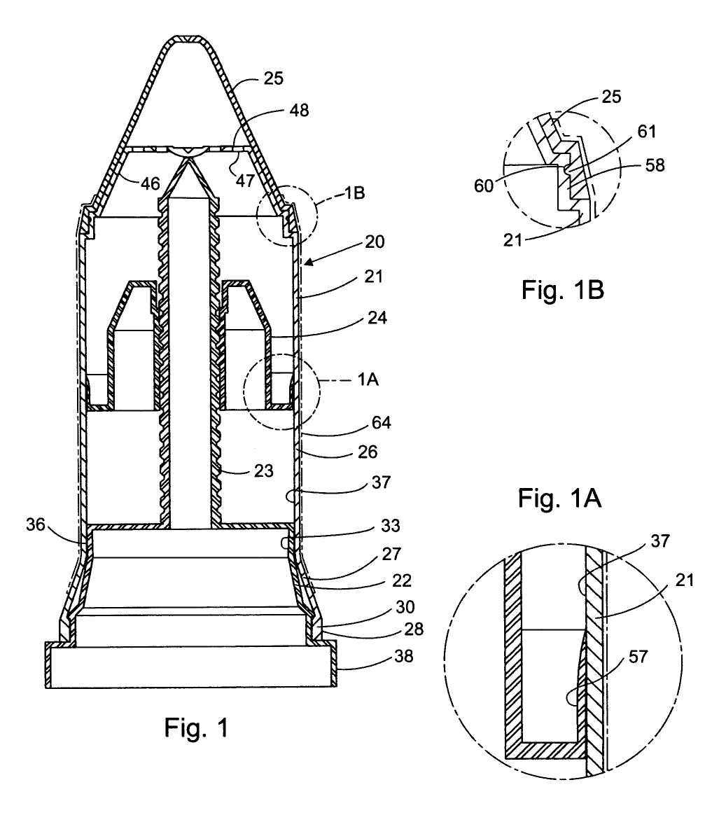

Referring now to the drawings in detail, reference is first made to FIG. 1, wherein a dispensing container is generally designated by the numeral 20, as comprising a one-piece generally stationary cylindrical outer wall member 21, having a one-piece bottom member 22 received therein, and rotatable relative thereto. The bottom member 22 includes an upstanding threaded shaft 23.

A piston member 24, vertically movable from a lower end of the threaded shaft 23, toward the upper end thereof, is provided, with rotation of the shaft driving the piston vertically upwardly along the threaded shaft 23, as the bottom member 22 is grasped and rotated, preferably clockwise, within and relative to the stationary cylindrical outer wall member 21.

A removable cap 25 is provided at the upper end of the dispensing container 20.

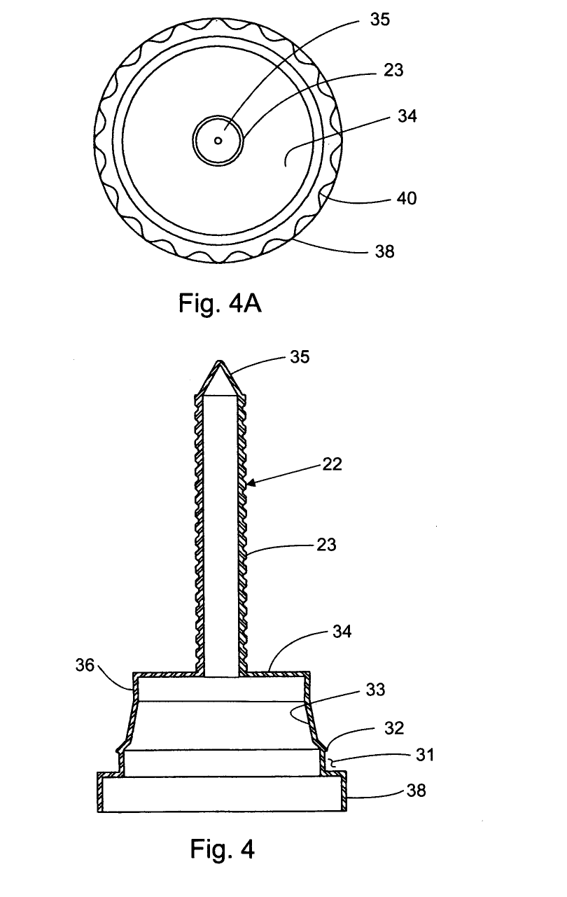

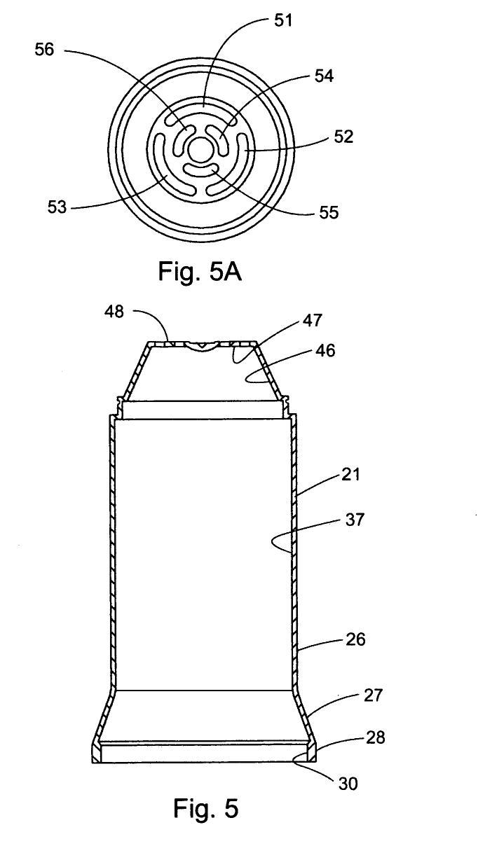

The cylindrical member 21 is provided with a generally central cylindrical portion 26, and its lower end flares outwardly at 27, to end in a sealing portion 28 at its lower end, which provides a cylindrical projection 30 extending inwardly thereof, as shown in FIG. 5, to engage within the circumferential channel 31 beneath the peripheral projection 32 of the bottom member 22, as shown in FIG. 4, for effecting sealing engagement therewith, as shown in FIG. 1.

The bottom member 22 as shown in FIG. 4 has an upstanding cylindrical wall 33 that ends in a transverse wall 34 as shown in FIG. 4, that carries the upstanding threaded shaft 23 that ends in a generally conically shaped upper end 35.

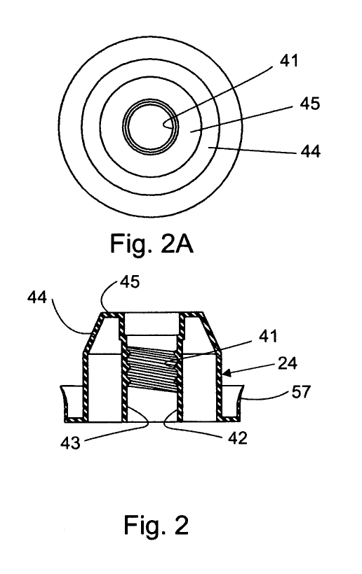

In addition to the seal that is effected by the sealing engagement of the peripheral inward projection 30 in the channel 31, between members 21 and 22, the outer periphery of the upper end of the wall 33, at 36 as shown in FIG. 4, slidingly engages along the inner diameter 37 of the stationary cylindrical outer wall 21, as the downwardly extending flange 38 of member 22 is grasped by the hand of a user, readily engageable with the undulations 40 thereof, as shown in FIG. 4A, such that the bottom member 22 can be rotated within the stationary cylindrical outer wall member 21. Such rotation of the bottom member 22, which causes rotation of the threaded shaft 23, causes the inter-engaging threads 41 of the piston member 24, on an inner, vertical, cylindrical surface 42 thereof, as shown in FIG. 2 to cause the piston 24 to move vertically upwardly, traversing the shaft 23.

It will be noted that the threads 41 on the interior of the piston 24 do not extend to the lower zone 43 of the cylindrical interior surface 42, as shown in FIG. 2, in order to provide a stop mechanism, to avoid stripping of threads and to avoid pushing the stationary cylindrical outer wall member 21 out of the sealing area 31 (FIG. 4) of the bottom member 22, upon upward-most movement of the piston 24.

The piston 24, at its upper outer end, has a frusto-conical configuration 44 and a generally flat upper end 45, that are adapted to mate, respectively, with complementally configured surfaces 46 and 47, comprising the upper end 48 of stationary cylindrical outer wall member 21, for ensuring maximum discharge of product through the upper end 48 of stationary member 21, as the piston 24 approaches the upper end thereof.

As shown in FIG. 5A, a shaped discharge of product is provided, in the form of three outer arcuately shaped openings 51, 52, 53, and three inner arcuately shaped discharge openings 54, 55 and 56, with the latter three shaped openings being located at locations that are spaced radially inwardly from the radially shaped openings 51, 52 and 53, all as shown in FIG. 5A.

Such a spacing of shaped openings as illustrated in FIG. 5A, provides a flower-like shaped product, for enhancing flow of product from the container, and for giving the appearance of a wider diameter discharge of product therefrom, as distinguished from the appearance of a product discharged from a single opening.

The piston 24, most specifically as shown FIGS. 1A and 2, is provided with a tapered peripheral seal 57, which thins down in an upward direction as shown in FIG. 1A, which seal, upon rotation of the bottom member 22, and riding of the piston 24 upwardly through the stationary cylindrical outer wall member 21, the sealing flange 57 slides along the cylindrical inner wall surface 37 of the stationary cylindrical outer wall member 21, for preventing undesirable discharge of product from within the container, downwardly, and outwardly, past the seal formed between the sealing portion 57 of piston 24 and the wall 37, such that product is scraped along the wall and pushed upwardly to discharge as the piston rides upwardly within the dispensing container.

As shown in FIG. 1B, the upper end of the stationary cylindrical outer wall member 21, has an upstanding portion 58, that is provided with a recess 60 therein, for receipt of an inwardly extending annular projection 61 of the one-piece removable cap 25 therein, in snap-engagement, such that the cap will remain in engagement over the discharge end of the stationary cylindrical outer wall member, until discharge therefrom is desired.

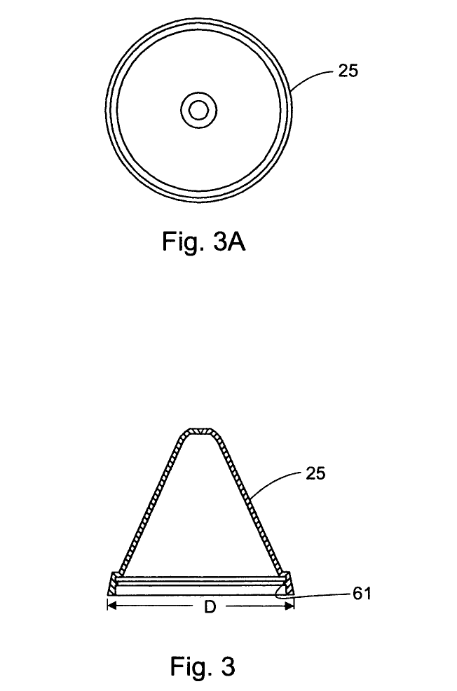

It will be noted, with reference to FIG. 3, that the diameter “D” of the cap 25 is selected for choke-hazard avoidance, and has a diameter “D” in excess of 1 inch, and most preferably, is approximately 1¼ inches in diameter.

With reference to FIG. 2, it will be shown that the sleeve-like sealing portion 57 of the piston 24, is configured to normally be directed outwardly in a radial direction, as shown in FIG. 4, such that, when it is contained within the inner cylindrical wall 37 of the stationary cylindrical outer wall member 21, the normal outward bias of the sealing portion 57 is restrained by the wall 37, so that is slides against the wall 37 with a force as will be determined by the outwardly inclined resilience of the sealing sleeve portion 57 of the piston 24.

A shrink-wrap covering 64, is provided, shown in phantom in FIG. 1, as an option, which covers and facilitates holding together the cap 25 and the stationery cylindrical outer wall member 21 until the dispensing container is ready for use. Such shrink-wrap may, if desired, be transparent, in order to allow visible images of the exterior of the cover 25 and stationary cylindrical outer wall member 21 to be viewed therethrough.

It will be apparent from the forgoing that other modifications may be made in details of construction to the various components of this invention, all within the spirit and scope of the invention as defined in the appended claims.

What is claimed is:

1. A dispensing container for containing and dispensing a viscous candy, gum or like product therefrom, having four molded plastic components; said components comprising:
(a) a one-piece stationary generally cylindrical outer wall member having upper and lower ends and a generally smooth interior surface and with the upper end having a shaped inner surface, being generally closed with dispensing opening(s) therethrough for dispensing product therefrom;
(b) a one-piece bottom member having upper and lower ends, received in and rotatable relative to the outer wall member and closing the same at the lower end thereof, with the bottom member having an upstanding threaded generally central shaft extending vertically up through the outer wall member toward the upper end thereof;
(c) a one-piece vertically moveable piston disposed inside said outer wall member and having an internally threaded generally central portion in threaded engagement with said shaft of said bottom member and being adapted to be axially moveable vertically inside said outer wall member upon rotation of said bottom member; with said piston having a sliding peripheral seal for maintaining sealing engagement against the generally smooth interior surface of the outer wall member as the piston moves vertically therethrough, to prevent vertically downward discharge of product between the moveable piston and the interior surface of the outer wall member; with the piston having a product-engaging upper shaped outer surface, for mating with the upper end inner surface of the outer wall member; and
(d) a one-piece removable cap for removably covering the upper end of the outer wall member above the dispensing opening(s).

2. The dispensing container of claim 1, wherein the shaped inner surface of the upper end of the stationary outer wall member and the product-engaging shaped outer surface are each complementally generally conically shaped to comprise means facilitating generally maximum discharge of product from the dispensing container as the piston approaches the shaped inner surface of the upper end of the stationary outer wall member.

3. The dispensing container of claim 1, wherein the internal thread of the internally threaded generally central portion of the piston extends from an upper end of the piston partway down the central portion of the piston, leaving an unthreaded central portion of the piston at a lower end of the piston.

4. The dispensing container of claim 1, wherein the bottom member has a generally outwardly opening cylindrical channel on the periphery thereof at its lower end, and wherein the outer wall member has a generally inwardly extending cylindrical bead at its lower end, with the bead and the channel comprising means effecting a seal for preventing discharge of product past the seal.

5. The dispensing container of claim 1, wherein the cap has means for removable snap-engagement with the upper end of the stationary outer wall member, and wherein the upper end of the stationary outer wall member has complemental means facilitating said snap-engagement.

6. The dispensing container of claim 1, wherein the cap has a diameter in excess of 1 inch in diameter, for choke-hazard avoidance.

7. The dispensing container of claim 6, wherein said cap diameter is approximately 1¼inches.

8. The dispensing container of claim 1, wherein the sliding peripheral seal of the piston has a configuration ending in an outer diameter larger than the diameter of the smooth interior surface of the outer wall member, for effecting a resiliently biased sealing engagement of said configuration against said smooth interior surface of the outer wall member.

9. The dispensing container of claim 8, wherein said configuration of said peripheral seal is tapered.

10. The dispensing container of claim 1, wherein the dispensing opening(s) of the stationary outer wall member comprise a plurality of arcuate openings.

11. The dispensing container of claim 10, wherein the stationary outer wall member has a central cylindrical axis and wherein there are two pluralities of arcuate openings at different radially spaced locations from said central cylindrical axis.

12. The dispensing container of claim 1, wherein a shrink-wrapped generally cylindrical thermoplastic covering is provided, covering at least substantial portions of components (a), and (d).

13. The dispensing container of claim 1, wherein said bottom member, at its lower end, on the outer periphery thereof, is provided with undulations facilitating manual grasping and rotation thereof relative to component (a).

14. The dispensing container of claim 1, wherein the shaped inner surface of the upper end of the stationary outer wall member and the product-engaging shaped outer surface are each complementally generally conically shaped to comprise means facilitating generally maximum discharge of product from the dispensing container as the piston approaches the shaped inner surface of the upper end of the stationary outer wall member, wherein the internal thread of the internally threaded generally central portion of the piston extends from an upper end of the piston partway down the central portion of the piston, leaving an unthreaded central portion of the piston at a lower end of the piston, wherein the bottom member has a generally outwardly opening cylindrical channel on the periphery thereof at its lower end, and wherein the outer wall member has a generally inwardly extending cylindrical bead at its lower end, with the bead and the channel comprising means effecting a seal for preventing discharge of product past the seal, wherein the cap has means for removable snap-engagement with the upper end of the stationary outer wall member, and wherein the upper end of the stationary outer wall member has complemental means facilitating said snap-engagement, wherein the cap has a diameter in excess of 1 inch in diameter, for choke-hazard avoidance, wherein the sliding peripheral seal of the piston has a tapered configuration ending in an outer diameter larger than the diameter of the smooth interior surface of the outer wall member, for effecting a resiliently biased sealing engagement of said tapered configuration against said smooth interior surface of the outer wall member and wherein the dispensing opening(s) of the stationary outer wall member comprise a plurality of arcuate openings.

15. The dispensing container of claim 14, wherein said cap diameter is approximately 1¼inches and wherein the stationary outer wall member has a central cylindrical axis and wherein there are two pluralities of arcuate openings at different radially spaced locations from said central cylindrical axis.

16. The dispensing container of claim 14, wherein a shrink-wrapped generally cylindrical thermoplastic covering is provided, covering at least substantial portions of components (a), (c) and (d) and wherein said bottom member, at its lower end, on the outer periphery thereof, is provided with undulations facilitating manual grasping and rotation thereof relative to component (a).
